(19) United States
(12) Patent Application Publication
(10) Pub. No.: US 2007/0057043 A1
(43) Pub. Date: Mar. 15, 2007

(54) Calling card with integrated banking functions

(75) Inventors: Gustavo M. de la Garza Ortega, Houston, TX (US); Alejandro Pessagno, Houston, TX (US); Maria Armida Porras Andujo, Col. San Jeronimo Monterrey (MX); Edgar Escudero Ramirez, Col. San Jeronimo Monterrey (MX)

Correspondence Address: ALBERT B. KIMBALL, JR.;BRACEWELL & PATTERSON L L P, 711 LOUISANA SUITE 2300, HOUSTON, TX, 77002, US

(73) Assignee: BILLETEL, LLC

(21) Appl. No.: 11/518,822

(22) Filed: Sep. 11, 2006

Related U.S. Application Data
(60) Provisional application No. 60/716,731, filed on Sep. 13, 2005.

(51) Int. Cl. G06K 5/00

(52) U.S. Cl. 235/380

(57) ABSTRACT

An integrated multi-serviced stored value card system permits and performs integrated telecommunication and financial services. A card affords the features of a traditional calling card plus a wide array of banking services, such as electronic fund transfers between cards and cash withdrawals, and telecommunication features. Stored values from a primary card according to the system are capable of allocating stored value balances to subsidiary or secondary cards for use by authorized subsidiary card users.

### REFERENCE TO RELATED APPLICATIONS

This application claims the benefit of U.S. Provisional Patent Application Ser. No. 60/716,731 which was filed Sep. 13, 2005.

### BACKGROUND OF INVENTION

1. Field of Invention

The present invention relates to a calling or telephone card integrated with a wide array of banking services that provides a new functionality in merging banking, telecommunication and money-transfer services.

2. Description of Prior Art

Use of stored value cards has become possible in recent years. Examples of such cards are those distributed in U.S. Pat. Nos. 6,000,608 and 6,189,787. Although such stored value cards are desirable, there are certain capabilities and functionalities which are, so far as is known, not presently available.

For example, users of stored value cards often might have need to allow others use of the funds represented by the values stored in such cars. However, the card holders typically would not, for a variety of reasons, have desired to allow unlimited or uncontrolled access to or use of the full amount of the stored values in their cards even by authorized persons.

In addition, the growth of types of credit cards and stored value cards has in itself caused problems. With a number of cards available for various specific purposes, it has become a problem to have several cards, each with different functionalities. There has been some apparent customer reluctance to multiple cards, and to having to carry and use different cards for each different functionality. Further, the different cards had different procedures of use, different access, security and password rules and other problems.

### SUMMARY OF INVENTION

Briefly, the present invention provides an integrated card and an integrated card system used therewith permitting an integrated cardholder or user with a single integrated card to utilize banking, telecommunication and money transfer services. The integrated card includes a unique and breakthrough multi-service stored value card that can repeatedly be reloaded at participant merchants around the world. The various features of the integrated card system can be accessed from any user access site accessible by the system, such as an automated voice response system (IVR system), the Internet, or a point of sale (POS) device. After a card is loaded, funds represented by the stored value can be withdrawn in a manner comparable to a personal identification number (PIN) debit card at any automatic teller machine (ATM) or point of sale (POS) device accepting PIN-based debit transactions anywhere in the world that is affiliated, as indicated by the displays various network logos printed on the back of the integrated card.

The integrated card in the preferred embodiment is sold to a user in a package including a primary card and a secondary card. The secondary card can be sent or given to another individual who may live in a separate location from the user of the primary card. Therefore, this secondary card allows for instantaneous money transfers between the primary and secondary card.

In addition to being able to be used as a stored value card, and a money transfer method, the integrated card also serves a traditional telephone or calling card for local and long distance calling, which also has enhanced capabilities related to a personal local telephone number in the United States, as well as, the ability to recharge prepaid mobile telephones.

One of the primary benefits of the present invention is that one card integrates in a single product all the features of an enhanced calling card, a wide array of banking services, plus money-transfer services providing a new functionality in merging banking, telecommunication, and money-transfer services. Furthermore, the integrated card allows a user the complete functionality of a traditional banking account without having to have a bank account in a specific location, city, state or region.

### BRIEF DESCRIPTION OF THE DRAWINGS

The objects, advantages and features of the invention will become more apparent by reference to the drawings appended thereto, wherein like numerals indicate like parts and wherein an illustrated embodiment of the invention is shown, of which:

FIGS. 1 is a front elevation view of an integrated card according to the present invention.

FIG. 1a is a rear elevation view of the integrated card of FIG. 1.

FIG. 2 shows an illustration of the integrated card system according to an embodiment of the present invention.

FIG. 3 is a flowchart block diagram of the steps for gaining access to the functions of the integrated card system.

FIG. 4 is a flowchart block diagram of the steps for utilizing the main menu of the integrated card system.

FIG. 5 is a flowchart block diagram of the steps for accessing the telephone functionality of the integrated card system.

FIG. 6 is a flowchart block diagram of the steps for making a phone call utilizing the integrated card system.

FIG. 7 is a flowchart block diagram of the steps for sending a direct message utilizing the integrated card system.

FIG. 8 is a flowchart block diagram of the steps for accessing the enhanced features for telephone functionality utilizing the integrated card system.

FIG. 9 is a flowchart block diagram of the steps for listening to a message utilizing the integrated card system.

FIG. 10 is a flowchart block diagram of the steps for listening to a saved message utilizing the integrated card system.

FIG. 11 is a flowchart block diagram of the steps for the “follow me” telephone functionality utilizing the integrated card system.

FIG. 12 is a flowchart block diagram of the steps for customizing a user's voicemail utilizing the integrated card system.

FIG. 13 is a flowchart block diagram of the steps for changing a personalized greeting utilizing the integrated card system.

FIG. 14 is a flowchart block diagram of the steps for utilizing the ATM functionality of the integrated card system.

FIG. 15 is a flowchart block diagram of the steps for utilizing the direct money transfer functionality of the integrated card system.

FIG. 16 is a flowchart block diagram of the steps for loading a calling card utilizing the integrated card system.

FIG. 17 is a flowchart block diagram of the steps for completing a card to card transfer utilizing the integrated card system.

FIG. 18 is a flowchart block diagram of additional steps for completing a card to card transfer utilizing the integrated card system.

FIG. 19 is a flowchart block diagram of the steps for completing a transaction review utilizing the integrated card system.

FIG. 20 is a flowchart block diagram of the steps for changing the access code for a card utilizing the integrated card system.

### DETAILED DESCRIPTION OF THE INVENTION

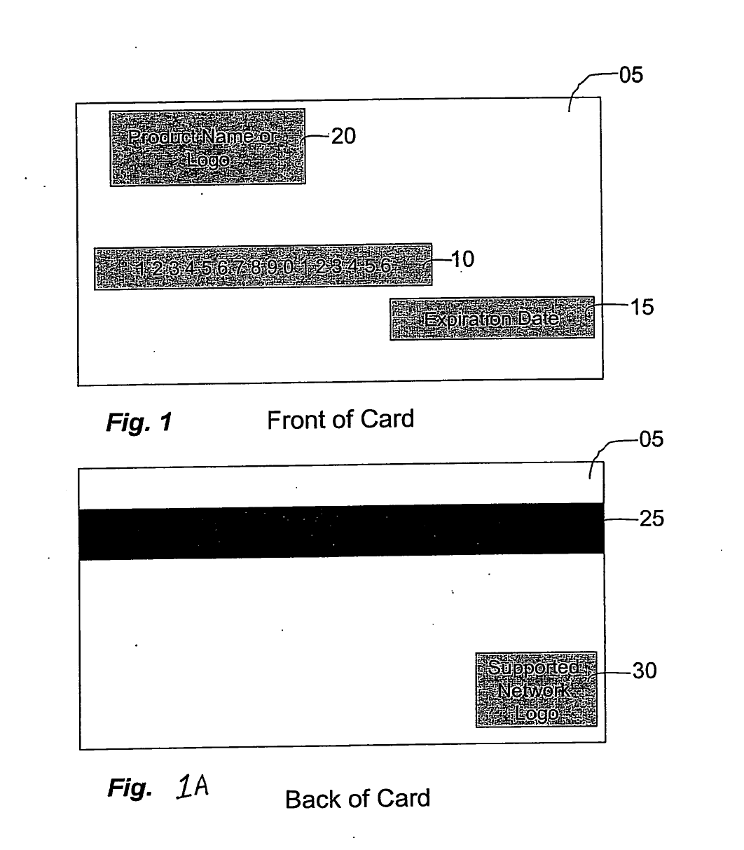

Referring to FIG. 1 and FIG. 1a, an example integrated card 5 that is part of an integrated card system according to the present invention is shown. The integrated card 5 may have several pieces of information displayed on the front elevation of card 5, and may include a sixteen digit integrated card account number 10, an expiration date 15, and an integrated card product name or logo 20. The integrated cards may be issued in a variety of ways, as will be described, and thus they need not necessarily be personalized with the user's name.

On the rear elevation, the integrated card 5 has a magnetic band 25 allowing for transactions at various types of POS devices including ATM and PIN-based POS devices. The necessary information for completing a transaction using integrated card 5 is encoded in the magnetic band 25, and may include information related to the integrated card 5 account number and an associated 4-digit PIN, both of which are generated and supplied by the banking institution. With the integrated card 5 account number and 4-digit PIN, a user can use the integrated card 5 to complete purchase transactions around the world at locations of a number of known banking or financial systems. The banking or financial systems accessible with the integrated card 5 could, for example, be any of those indicated by the display a supported network logo 30—such as Master Card®, Maestro®, Cirrus®, Star®—found on the rear elevation of integrated card 5.

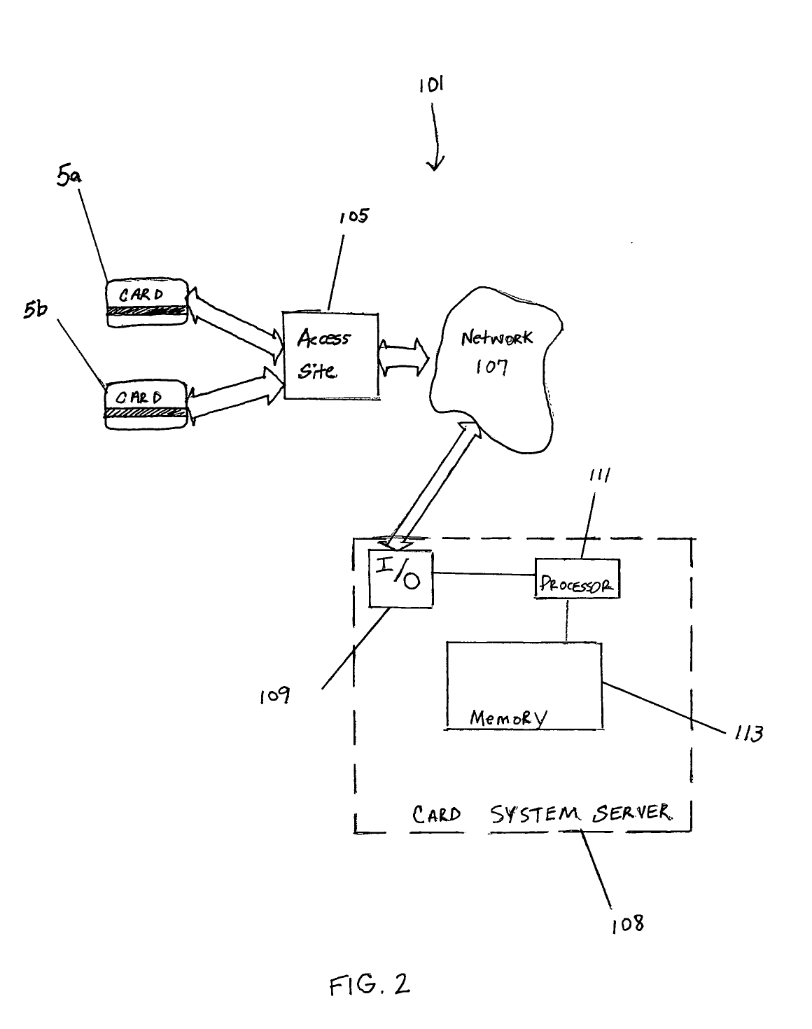

Integrated card 5 may be sold to a user at a retail location, financial institution, over the telephone, over the Internet or through some other distribution channel. Referring to FIG. 2a, in the preferred embodiment, when a user purchases integrated card 5, the user receives two cards, a primary card 5a and secondary card 5b. Furthermore, the secondary card 5b comes with a pre-paid, ready to send envelope to facilitate mail, courier, or other service for fast and secure delivery of the secondary card to some other person to whom the owner of the primary card desires to grant card use privileges.

The integrated card system 101 includes at least one primary integrated card 5a and one associated or linked secondary card 5b, similar in appearance and characteristics of integrated card 5a. It is contemplated that the primary integrated card 5a and one or more associated or linked cards 5b may be located in different geographical areas, and even in fact different countries. The shape and size of integrated card 5, and the characteristics and functionality of magnetic band 20 are similar to existing PIN-based debit cards and thus of the conventional type.

In the preferred embodiment, the integrated card system 101 has two accounts: an ATM or funds account available for purchases and withdrawals; and a calling card account. The two accounts are linked to each other by the integrated card system, and the ATM account can be used to fund, reload, or recharge the calling card account.

In FIG. 2, the integrated card system 101 is illustrated. In its most preferred embodiment, the users possess the primary card 5a and secondary card 5b. The user is allowed to access the card system server 108 through user access site 105, which can be an automated voice response system, the Internet, a point of sale device, or the telephone system. Once the user has accessed the system through the user access site 105, the user can communicate with card system server 108 via network 107, which could be any wired or wireless bi-directional communications link, such as the Internet, cable, or satellite telecommunications networks.

Card system server 108 can be a mainframe computer of any conventional type having suitable processing capacity such as those available from International Business Machines (IBM) of Armonk, N.Y. or any other source. Other digital processors, however, maybe used, such as a laptop computer or any other suitable processing apparatus. In the preferred embodiment, card system server 108 will include a traditional input/output device 109, which could be a wired or wireless modem, network interface card, or any other suitable bi-directional communications means. A processor 111 is also in communication with the input/output device 109, which will control the various features provided by the present invention. A suitable high capacity data storage or memory device 113 is in communication with the processor 111, which is used to store various data such as user account and security information, voice mail, stored audio message voice codes for use in the automated voice response system, and other data necessary to practice the present invention.

When a user accesses the IVR for the first time, the telephony services account and voicemail box for that cardholder is automatically created at that moment. From there, the cardholder is allowed to make calls and receive voice messages that can be retrieved from the mailbox. The stored value platform is fully integrated with the telephony accounts system so funds can be transferred from one account to the other seamlessly. Hence, introduction of new telephony and prepaid related services is possible as the funds reserved in the telephony account can be used not only to consume calling minutes thru the built-in telephony platform but also to purchase, for instance, PIN-based cellular air time or even interconnect with third parties services providers to pre-pay or post-pay multiple services.

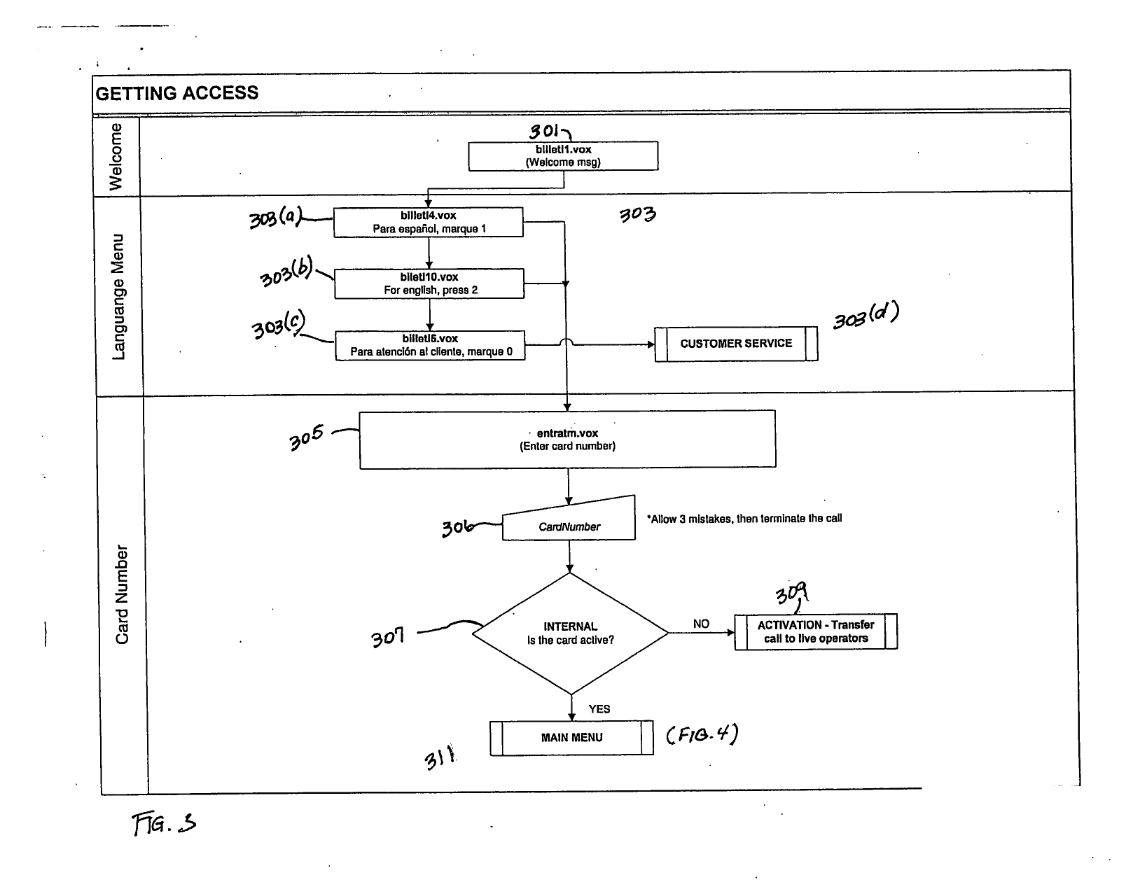

The flow charts, FIGS. 3-20, herein illustrates the structure of the logic of the present invention as embodied in computer program software performable on a mainframe, personal computer or other form of programmable control device. Those skilled in the art will appreciate that the flow charts illustrate the structures of computer program code elements including logic circuits on an integrated circuit that function according to this invention. Additionally, the flowcharts disclose the functions of the software that would be readily apparent to one of even nominal skill in the art. Furthermore, the flow charts are readily convertible into any of a number of computer program languages based on the type of computer in which the present invention is implemented. Manifestly, the invention is practiced in its essential embodiment by a machine component that renders the program code elements in a form that instructs a digital processing apparatus (that is, a computer) to perform a sequence of function steps corresponding to those shown.

It is important to note that, while the present invention has been, and will continue to be, described in the context of a fully functional digital platform, those skilled in the art will appreciate that the present invention is capable of being distributed as a program product in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links.

In the drawings, the high level flowchart of FIG. 3 shows a sequence of steps performed in connection with card system server 108 (FIG. 2) according to the present invention. Referring to FIG. 3, after the user purchases the integrated card 5, the user has to activate the integrated card 5. In the preferred embodiment, the integrated card 5 is activated by calling a toll free number in the United States. The toll free number is answered by an automatic voice response system (IVR system). Once the user is in the system, the processor 111 retrieves and plays a stored audio welcome message from the memory 113 at step 301. The customer then makes a series of selections from the menu items presented by the IVR system, including for example, in what language the menu items should be presented to the user as shown in step 303. The languages can be Spanish (step 303a), English (303b), or the user can choose to speak with customer service in step 303c. Once the user makes a language selection via the telephone keypad, the processor 111 calls the requested language from its memory 113. Also, during this time, the user will have the option to talk to a live operator at customer service (step 303d) in order to get more user friendly assistance, or the user can choose to use the IVR simply by making a selection on the telephone keypad.

The information and selections made during the call may be entered directly into the IVR system using the telephone keypad, or the user can speak with a customer service operator. Once a language has been selected and retrieved by the processor 111, the processor 111 then retrieves an audio message from its memory 113 which prompts the user to enter the card number at step 305. At step 306, the user is allowed three opportunities to enter the correct number. If the user fails, the processor 111 automatically terminates the call.

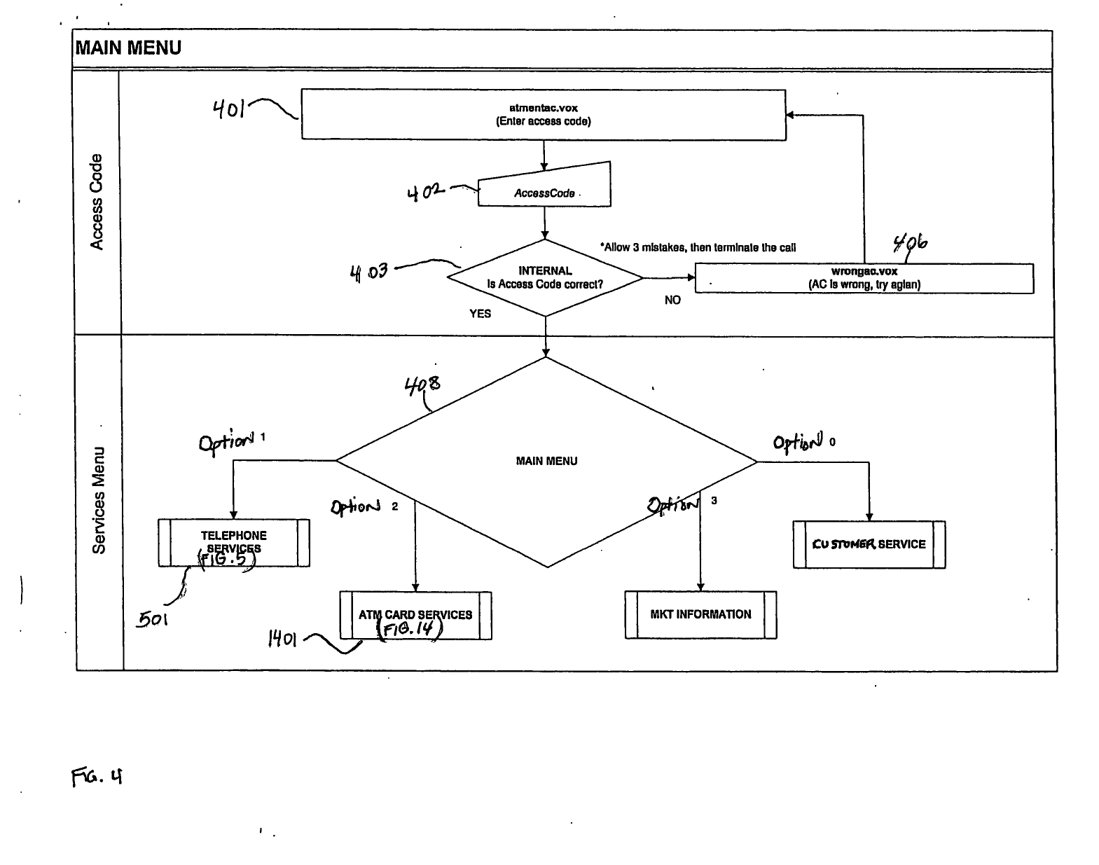

To complete the activation of the integrated card 5, the user has to enter the integrated card 5 account number into the IVR system or provide the information to the operator. At step 307, the integrated card 5 is then validated by the processor 111 in a card database (not shown) located in a suitable memory within the computer network. If the user properly entered the information into the IVR system, then the processor 111 transfers the user to a customer service operator at step 309, who collects required personal information related to user of the integrated card 5. Such personal information may be a first and last name, address, birth date, or any other valid identification information recognized by the United States Government or other entity. However, if the processor 111 determines the card number is already active on the computer network, the processor 111 will return the user to the main menu (FIG. 4) at step 311.

Once the personal information is collected by the customer service operator, the integrated card 5 is activated and ready for use. The customer service operator then transfers the user back to the IVR system so that the user may receive the PIN information for the integrated card 5 necessary to make ATM withdrawals and purchase transactions at a POS.

Each subsequent time the user accesses the IVR system, the user will begin the process by following the steps in FIG. 3. In an alternate embodiment, the user may access the integrated card system over the Internet.

Once the user has activated the integrated card, each subsequent time the user accesses the IVR system according to FIG. 3, the processor 111 automatically transfers the user to a main menu and step 401 disclosed in FIG. 4. At step 401, the user processor 111 calls from memory 113 a stored audio message which prompts the user to enter an access code. The access code works as a unique electronic identifier code which is required to access the system for security purposes.

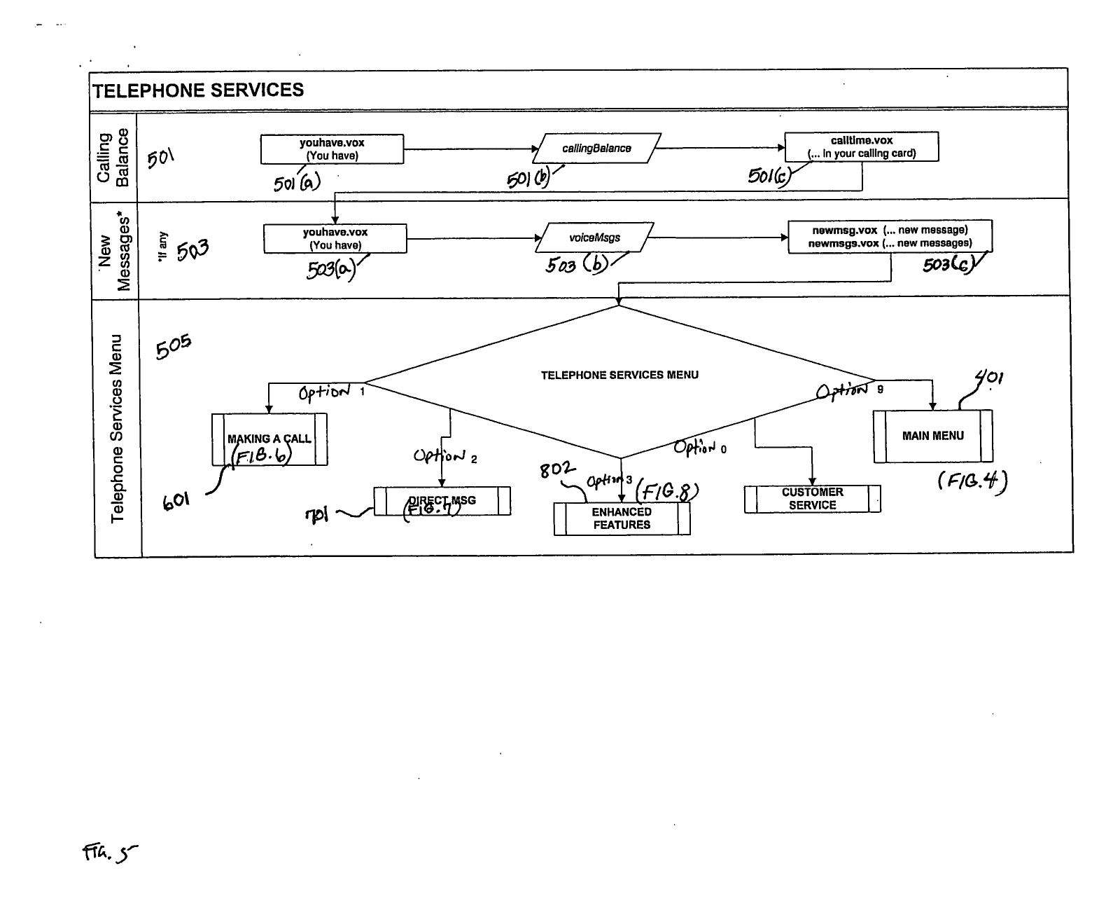

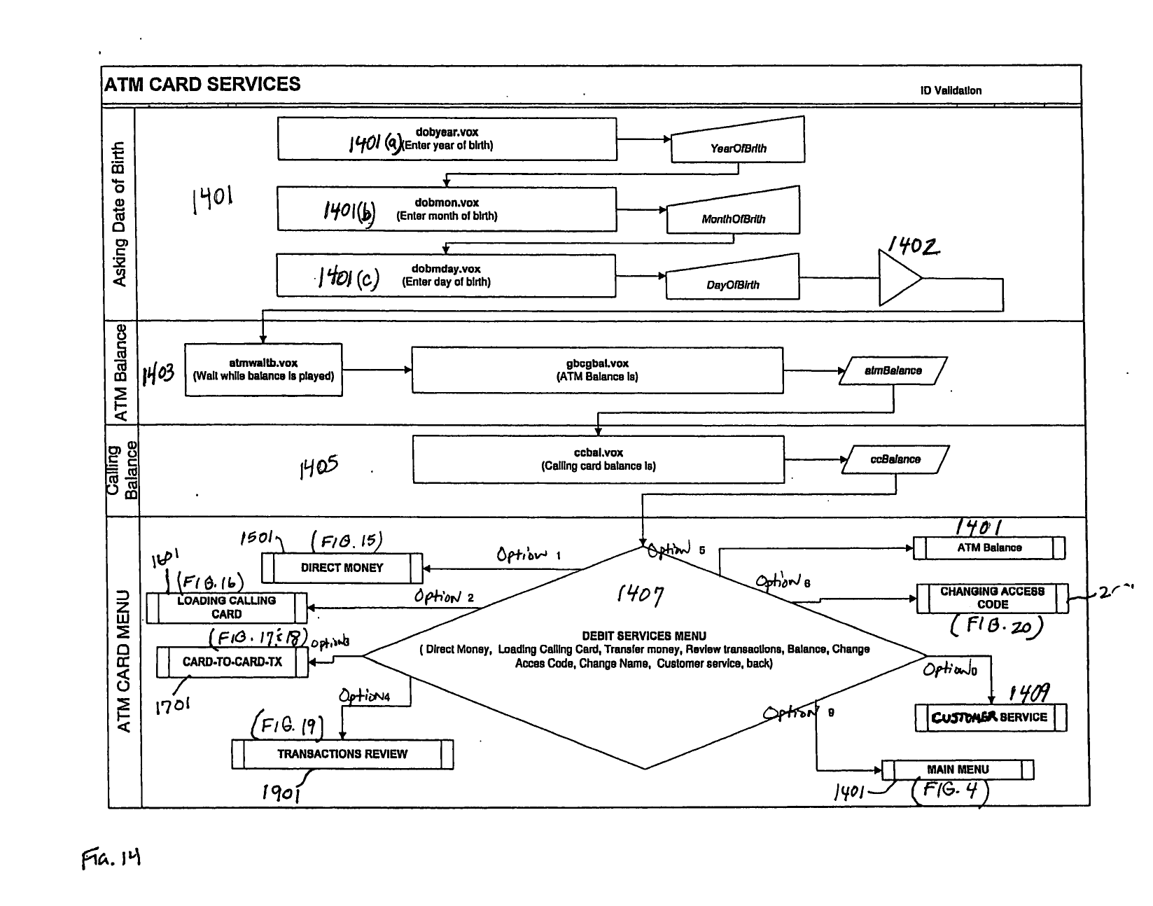

At step 402, the user enters the access code. Once entered, the processor 111 compares the entered access code to a valid access code database (not shown) accessible from memory on the network to determine whether the access code is correct at step 403. If the processor 111 determines the code is incorrect, the processor 111 will call from the memory 113 a stored audio message asking the user to re-enter the access code at step 406. In the preferred embodiment, the user is given three opportunities to enter the correct access code. If the user fails to enter the code each of the three opportunities, the system processor 111 terminates the call. If the user enters the correct access code on the telephone keypad, the system processor 111 allows the user to access the main menu at step 408. At the main menu, the processor 111 calls from the memory 113 a stored audio message which replays the four options available to the user: Option #1 being telephone services (FIG. 5), Option #2 being ATM card services (FIG. 14), Option #3 being Marketing information, and Option #0 being Customer service. Once selected, the system processor 111 forwards the user to the requested system automation.

In the preferred embodiment, referring to FIG. 5, once the user selects the telephone services option at the main menu, the system processor 111 allows the user to access the user's calling card balance, messages, or other telephone services such as making a call, direct messaging, customer services, enhanced features, or the main menu. An advantage over prior art calling cards and integrated calling and financial cards, is that the integrated card 5 of the present invention can be associated with a United States telephone number where the user can receive messages, or route calls received by the telephone number associated with the integrated card 5 to another telephone number.

In the preferred embodiment, referring to the high level flow chart of FIG. 5, if the user selects the telephone functions option (Option #1) from the main menu of FIG. 4, the processor 111 allows the user access to the portion of the system disclosed in FIG. 5, where the user then selects from a variety of telecommunications options. These options include the calling balance (step 501), checking new messages (step 503), or being directed to the Telephone Services menu (step 505) where the user is allowed to access other features which will be discussed below.

Various options are available under the Telephone Services feature. If the user selects card balance at step 501, the processor 111 calls from the memory 113 and recites the remaining balance of time left on the calling card at steps 501 a, b, and c. If the user selects the new messages option (step 503), the processor 111 calls from memory 113 and recites the number of new messages, if any, in step 503a. At steps 503b and c, the processor 111 calls from its memory 113 and begins at the first new message to replay any new messages on the system.

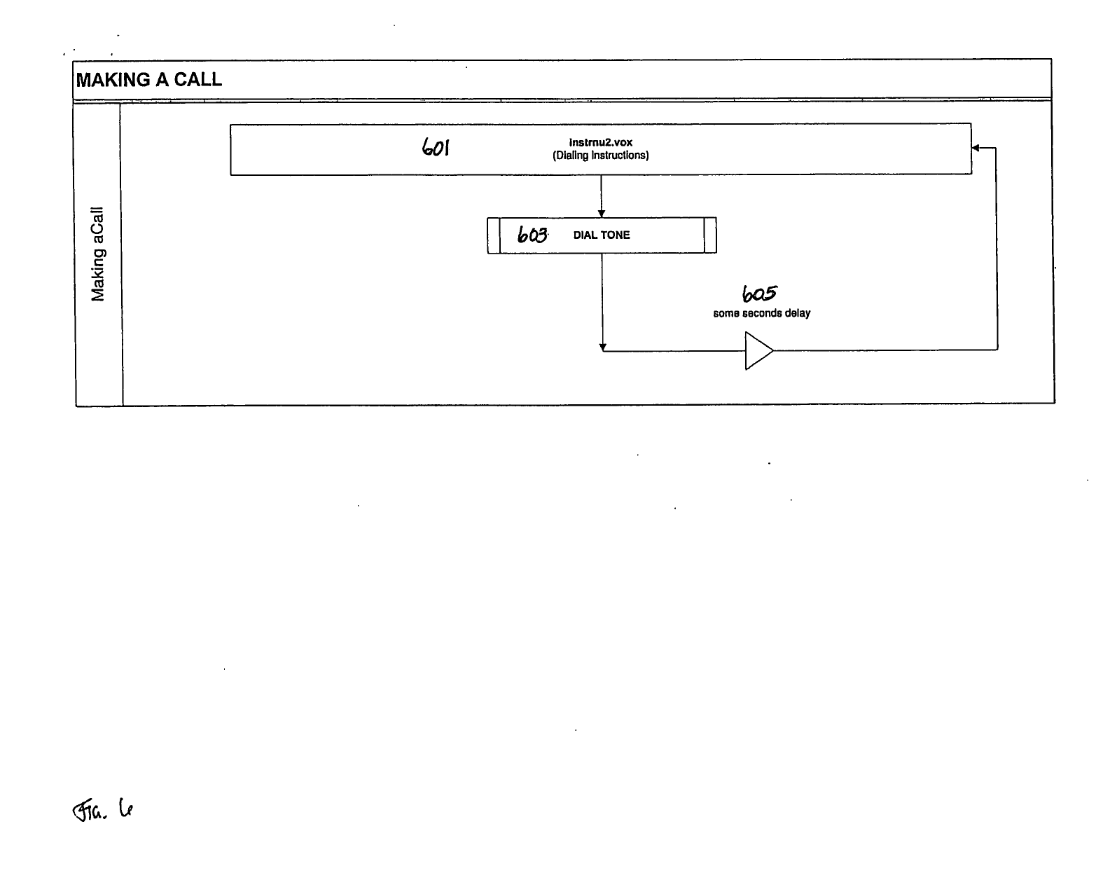

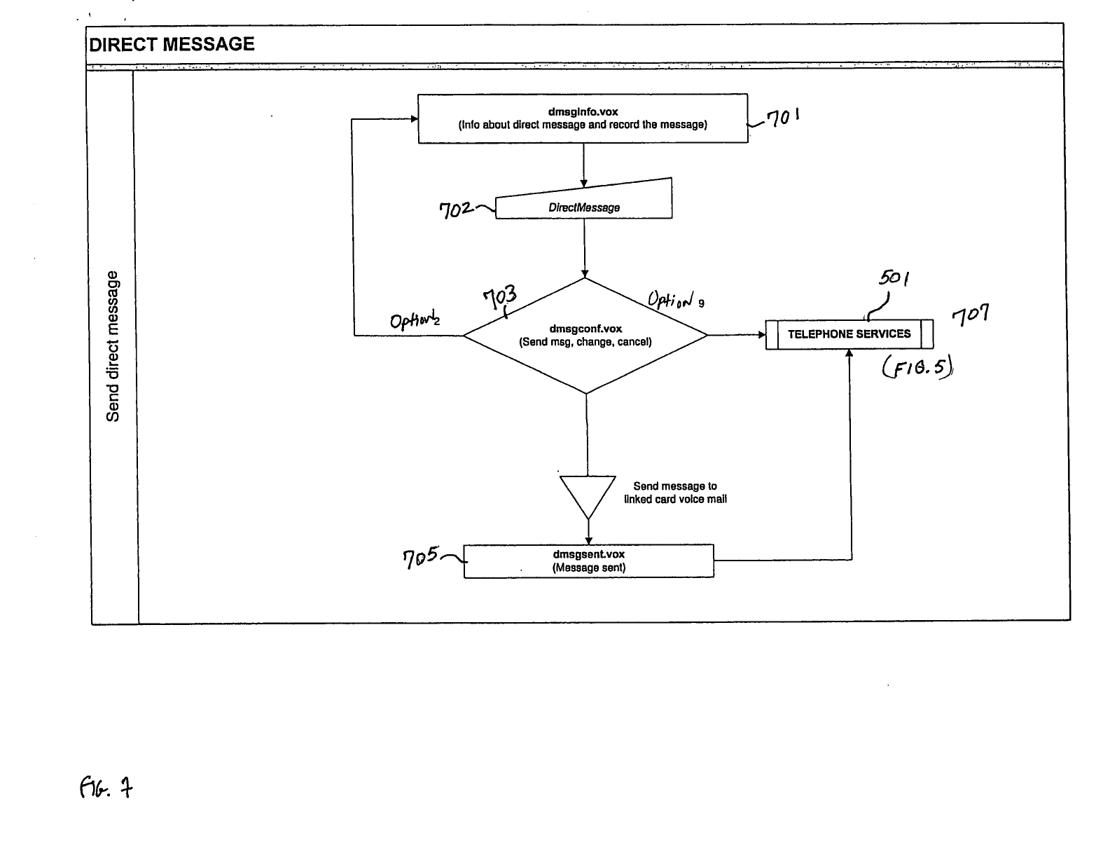

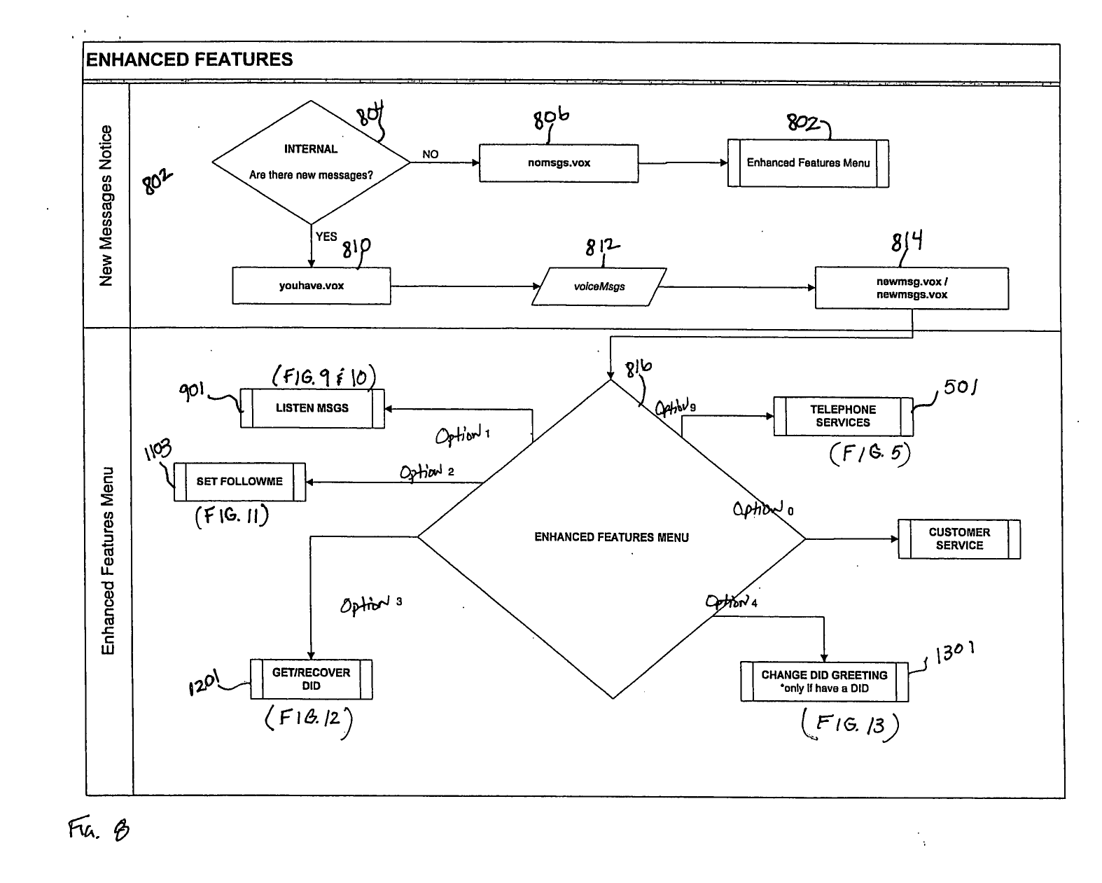

If, however, the user selects the telephone services menu at step 505, the processor 111 directs the user to the Telephone Services main menu which offers the user the following options: Option #1 allowing the user to access the Making a Call feature (FIG. 6), Option #2 being the Direct Messaging feature (FIG. 7), Option #3 being Enhanced Features (FIG. 8), Option #0 being Customer Service, and Option #9 being the main menu (FIG. 4). Once selected, the processor 111 forwards the user to the requested system automation.

In the preferred embodiment, referring to FIG. 6, the integrated card 5 can be used to make telephone local, national or international telephone calls. At step 601, the processor 111 calls from memory 113 a stored audio message which replays dialing instructions. Once complete, the system processor 111 then causes the system to sound a dial tone at step 603. Once the user hears the dial tone, he or she enters the telephone number in the keypad. If the telephone number is not entered in a predetermined amount of time (seconds), at step 605 the processor 111 forwards the user back to step 601. If the user successfully enters the telephone number, the processor 111 prompts the network to connect the call.

In the preferred embodiment, the user can make consecutive calls. At the beginning and end of each call the IVR system informs the user of the calling card balance by prompting the processor 111 to recall the balance from the memory 113. Once the user enters a telephone number, the processor 111 then calls a stored audio message from the memory 113 which informs the user of the number of minutes the user has to speak with people at the chosen telephone number based on the user's current calling card balance. When only one (1) minute of calling time remains, the IVR will play a warning message and gives the user the option of transferring money to the calling card balance. These features allow the user to make calls while controlling the calling card balance. As such, the user is allowed to recharge the card 5 in real-time while on a phone call. An additional benefit is that the user knows the exact costs being spent on making telephone calls which can be used by the user to determine the cost per minute of calling time offered.

Referring to FIG. 7, in addition to being able to make telephone calls, the user can also access the Direct Messaging feature. This feature allows the user to send direct or express voice-mail messages to linked cards without having to type, or otherwise indicate or enter the card number to which the user wants to send the message. Additionally, the user can send a message to any other user on the integrated card system by simply keying the card number into the IVR system.

In FIG. 7, after selecting the direct message feature, the system processor 111 calls from memory 113 a stored audio message which replays information concerning the direct message feature and recording messages at step 701. This feature allows the user to automatically send a message to the linked card without entering the card number. Once the user records the messages at step 702, the processor 111 then stores the message in the memory 113 and the user is then allowed to send, change, or cancel the message at step 703. If the user chooses to change or cancel the message, the user selects Option #2 and the system processor 111 directs the user back to step 701. However, if the user chooses to send the message, at step 705, the system processor 111 retrieves the message from its memory 113 and sends it directly to the linked card. Also, at step 703, the user may choose Option #9, which at step 707 causes the system processor 111 to redirect the user to the telephone services menu (FIG. 5, step 501).

In the preferred embodiment, referring to FIGS. 8-13, the user has access to several enhanced telephone functions including voice mail and “follow me” functions. The user accesses the IVR system as discussed above, and can retrieve messages left at the United States telephone number associated with the integrated card 5 account number. The user can listen to messages, hear the number of messages on the system, delete messages, or save messages as shown in FIG. 8. While in the listen to messages feature, the user is also allowed to skip or go back to messages, hear the date and time of messages, or any other manipulation of messages in the conventional manner.

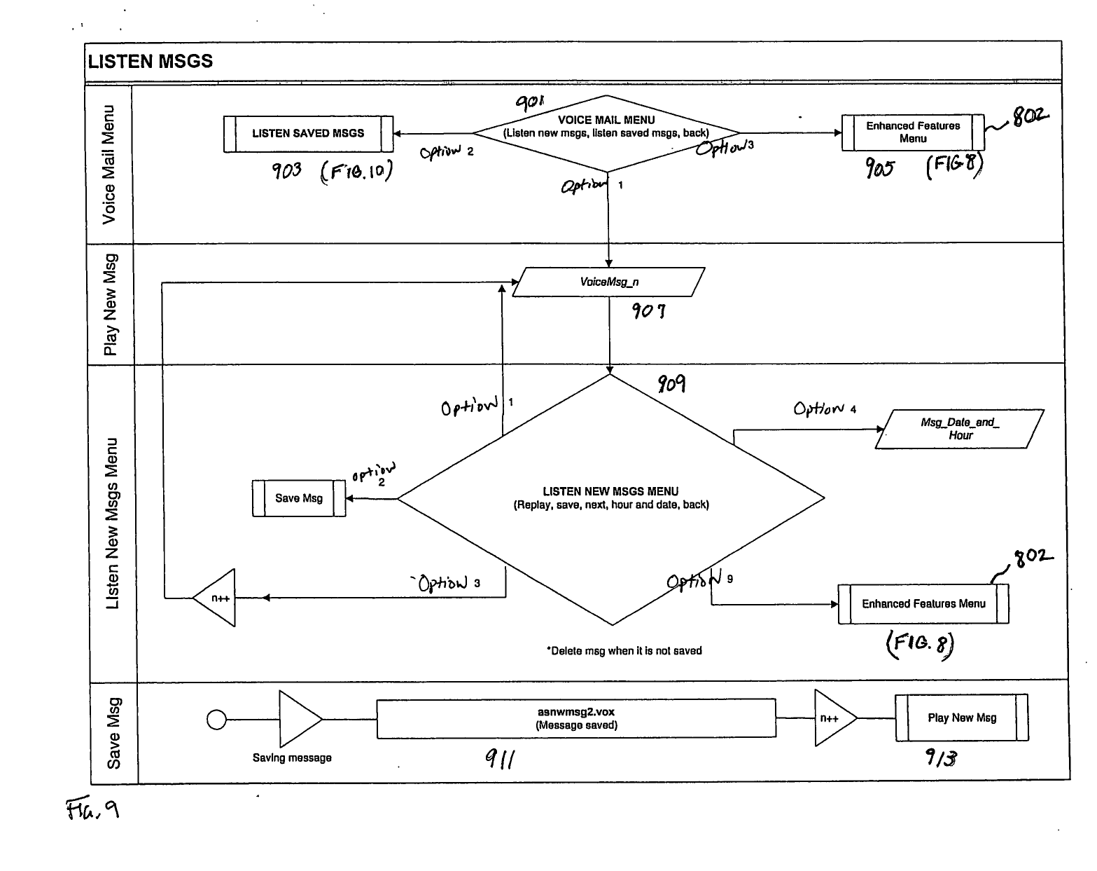

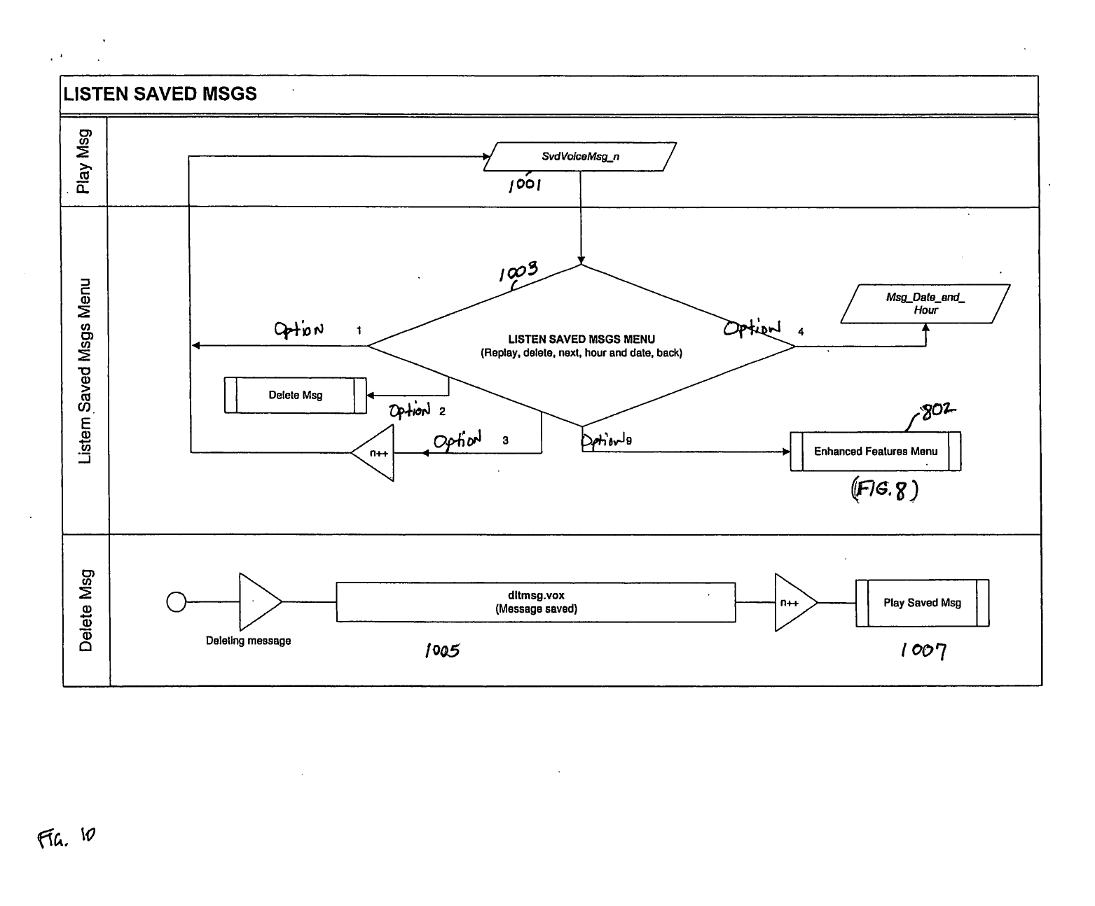

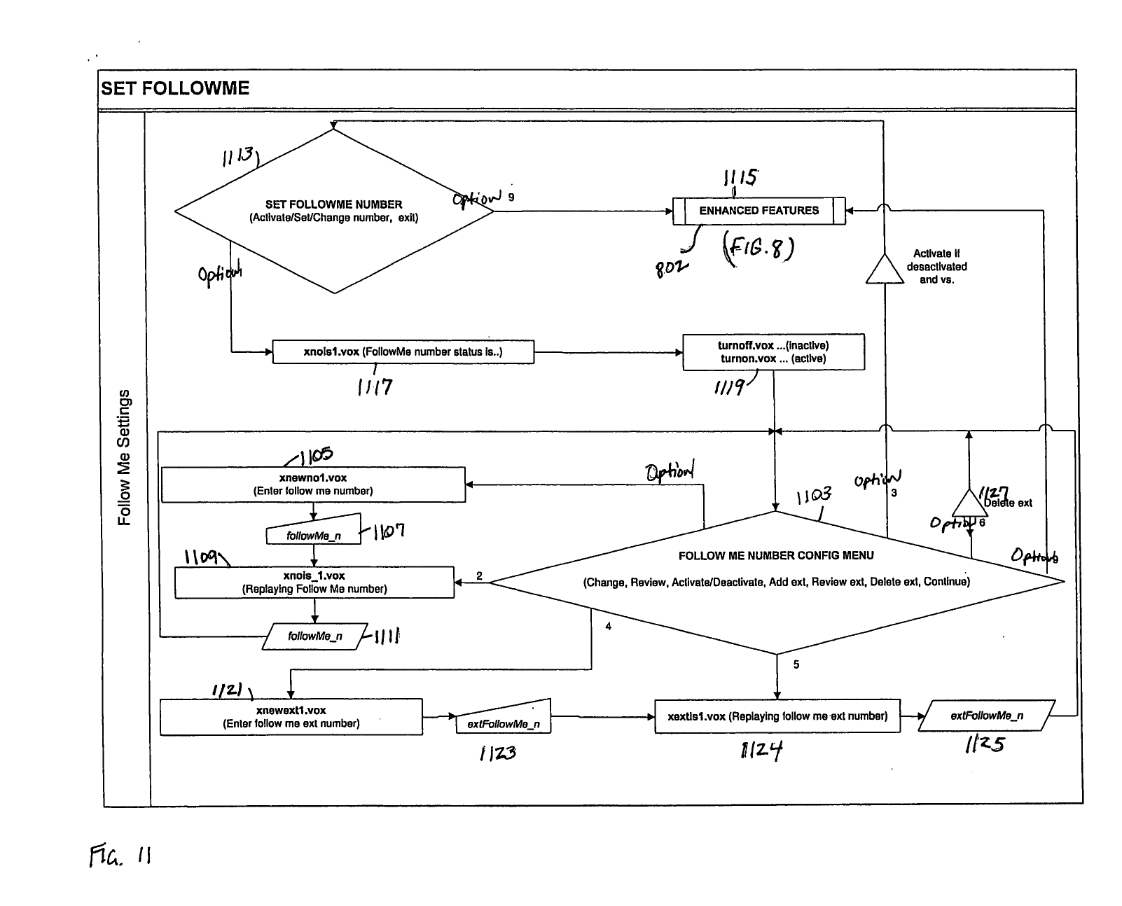

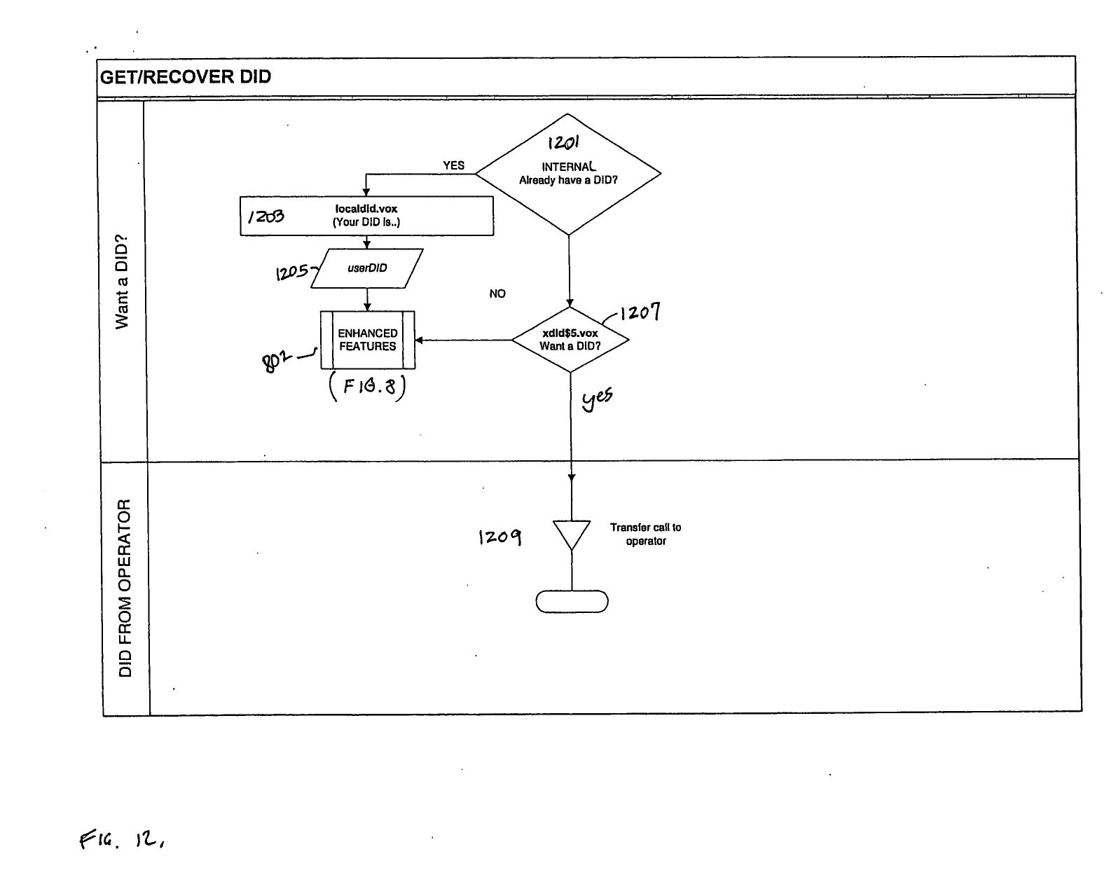

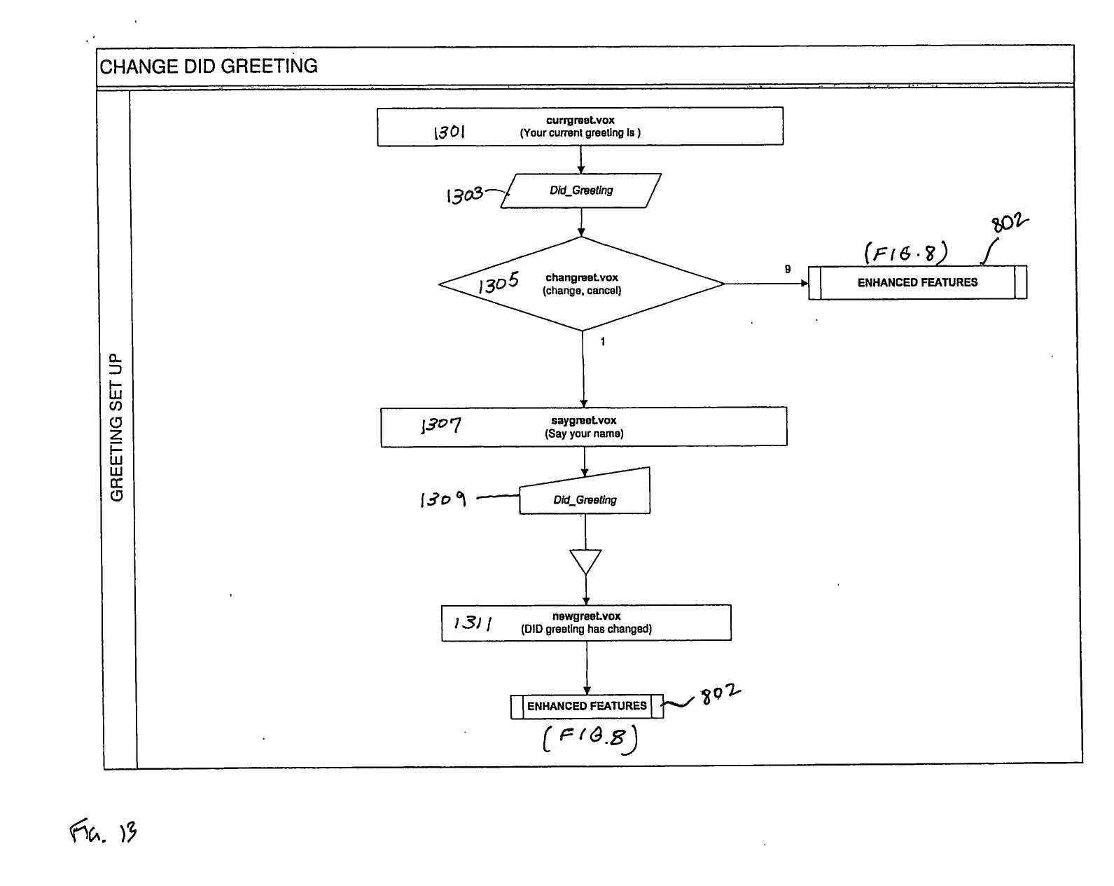

As shown in the high level flow chart of FIG. 8, the user has selected the Enhanced Features option 802. Here, the system processor 111 checks the memory 113 to determine at step 804 whether there are any new messages in the memory 113. If the there are no messages, the processor 111 retrieves an audio message from the memory 113 which informs the user there are no new messages at step 806. The processor 111 then forwards the user directly to the enhanced features main menu at step 816. However, if there are new messages in the memory 113, the processor 111 retrieves the messages (as well as the number of new messages) from the memory 113 and replays the number of new messages as shown in steps 810, 812, and 814. After this, the system processor 111 forwards the user to the enhanced features menu at step 816. Here, processor 111 retrieves the necessary audio messages from the memory 113 which replay the following options: Option #1 allowing the user to listen to the messages (FIGS. 9 and 10), Option #2 being the Set Follow Me feature (FIG. 11), Option #3 being the Get/Recover DID feature (FIG. 12), Option #4 being the Change DID Greeting (FIG. 13), Option #0 being Customer Service, and Option #9 being Telephone Services (FIG. 5). Once selected, the user is prompted to the requested system automation.

Referring to the high level flow chart of FIG. 9, the user is also allowed to access the Listen to Messages feature. At step 901, the user has accessed the voice mail main menu and system processor 111 retrieves stored audio messages from the memory 113 which gives the user the option of listening to new or saved messages. If the user selects Option #2, system processor 111 retrieves the necessary message or messages from memory 113 and replays the saved messages at step 903 (FIG. 10). If the user selects Option #3, system processor 111 forwards the user back to the Enhanced Features menu (FIG. 8) at step 905. If, however, the user selects Option #1, system processor 111 retrieves the necessary messages from the memory 113 and replays the new message at step 907.

After the new message has been replayed at step 907, at step 909 processor 111 gives the user the option of replaying the message (Option #3), saving the message (Option #2), hearing the message date and hour (Option #4), or going to the Enhanced Features Menu of FIG. 8 (Option #9). If the user selects Option #2 after listening to a message, system processor 111 directs the system to save the message in the memory 113 at step 911. Processor 111 then allows the user to begin listening to other new messages at step 913. If the user does not direct processor 111 to save the message, processor 111 automatically deletes the message from the memory 113. In FIG. 9, reference to M is the number of voice messages stored in the voice mailbox. N is the message number currently been played or deleted. N++means that the system moves forward to the next stored message.

As shown in the high level flow chart of FIG. 10, at step 1003 the user accesses the saved messages feature. At step 1003, system processor 111 retrieves the necessary messages from the memory 113 and replays various options from the saved messages main menu. Option #1 allows the user to replay save messages and forwards the user to step 1001 and begin replaying the message. After the message has been replayed, system processor 111 forwards the user back to the main menu of step 1003. If the user selects Option #2, system processor 111 deletes the message from the memory 113 at step 1005. After this is done, processor 111 begins retrieving and playing the saved messages from the memory 113 at step 1007. If, however, the user selects Option #3, system processor 111 allows the user to skip to the next message at step 1001. If the user selects Option #9, system processor 111 forwards the user to the Enhanced Features menu of FIG. 8. Lastly, if the user selects Option #4, system processor 111 retrieves from the memory 113 and replays the date and hour of the message.

The high level flow chart of FIG. 11, the user can as shown, use the “follow me” functions to forward calls to the number associated with the integrated card 5 account number to another telephone number. In this feature, among other functions, the user is allowed to set, change, review, or deactivate the follow me numbers. Thus, the calling card is not only associated with a telephone number where messages can be left and reviewed, but also incorporates a call forwarding feature.

Referring to the high level flow chart of FIG. 11, the user accesses the “Set Follow Me” feature of the present invention. This feature allows the user to enter a number in which the user calls will be forwarded. Here, system processor 111 first forwards the user to the main menu at step 1103 and gives various options contained in messages stored on the memory 113. If the user selects Option #1, processor 111 prompts the user to enter the follow me number at step 1105. The user then enters the number at step 1107. At step 1109, processor 111 replays the entered number and stores it in the memory 113. Once replayed at step 1131, the system forwards the user back to the main menu. If, however, the user selects Option #2, processor 111 allows the user to review the follow me number that is currently set on the system at step 1109 by retrieving the number from the memory 113. Here, again, processor 111 replays the number and then forwards the user back to the main menu at step 1131.

If the user selects Option #3, the system forwards the user to step 1133, where the system processor 111 gives the option of activating or deactivating a follow me number. If the user selects Option #1, system processor 111 retrieves from the memory 113 and replay the status of the current follow me number at step 1137. At step 1139, processor 111 checks and replays the status of the current number as active or inactive. After this is done, processor 111 forwards the user back to the main menu of step 1103. If, however, the user selects Option #9, processor 111 transfers the user to the Enhanced Features menu (FIG. 8) at step 1135.

If the user selects Option #4, the user is allow to add an extra follow me number at step 1121. At step 1123 the number is entered and processor 111 stores the number in the memory 113 and replays the extra number at step 1124. After the number has been replayed, at step 1125, the processor 111 forwards the user back to the main menu of step 1103. If, however, the user selects Option #5, processor 111 forwards the user to step 1124, where the extra follow me number is replayed. After the number is replayed, at step 1125, processor 111 forwards the user back to the main menu of step 1103.

If the user selects Option #6, processor 111 deletes the current follow me number from the memory 113 at step 1127. After the message is deleted processor 111 then forwards the user back to the main menu of step 1103. Lastly, if the user selects Option #9, processor 111 forwards the user to the Enhanced Features menu of FIG. 8.

In the preferred embodiment, referring now to the high level flow chart of FIG. 12, the user has now accessed the Get/Recover DID feature of the present invention. DID is an acronym for “direct inward dialing,” which is a feature that allows an outside caller to dial a phone number that will ring directly to a specific party instead of calling a main phone number. At step 1201, the processor 111 checks the memory 113 to determine whether the user has a DID. If processor 111 determines the user does have a DID at step 1203, processor 111 recalls the DID from the memory 113 and replays it at step 1205. After the DID has been replay by processor 111, processor 111 forwards the user to the Enhanced Features main menu (step 816) as discussed above in relation to FIG. 8. If, however, processor 111 determines the user does not have a DID, processor 111 retrieves a message from the memory 113 which asks the user whether he or she wants to acquire a DID at step 1207. If the user enters a no response on the keypad, processor 111 forwards the user to the Enhanced Features menu (step 816) discussed under FIG. 8. If, however, the user chooses to acquire a DID, processor 111 forwards the user to a system operator at step 1209, who assists the user in acquiring the DID.

Additionally, as shown in FIG. 13, the user can record and manipulate personalized messages for the user's voicemail that will be played each time someone calls the user. At step 1301, processor 111 retrieves from the memory 113 and replays the user's current greeting at step 1303. At step 1305, processor 111 retrieves from memory 113 and replays a message which gives the user the option of changing or canceling the current greeting. If the user selects Option #9, which allows the user to cancel the current greeting, the processor 111 forwards the user back to the Enhanced Features main menu discussed in relation to FIG. 8 above. If, however, the user selects Option #1, the system processor 111 retrieves a message from the memory 113 which prompts the user to say his or her name (or record a message) at step 1307. Once spoken, processor 111 replays the name at step 1309 and then directs the memory 113 to store the DID greeting at step 1311. Once changed and stored, processor 111 forwards the user to the Enhanced Features main menu (step 816) discussed in FIG. 8.

The banking features of the integrated card 5 also include both purchase and withdrawal transactions, and several features that are accessed over the IVR system. In a standard purchase transaction or withdrawal, the integrated card 5 is presented to cover the cost of a purchase at a PIN-based POS device, or at an ATM machine that have a supported network logo 30.

In the preferred embodiment, referring to FIG. 14, under the IVR system ATM Card Services features, processor 111 retrieves a stored audio message from memory 113 which asks the user to enter necessary security information at step 1401. This information can be the user's year of birth, month of birth, and day of birth or any other valid identification recognized by the United States Government or other recognized entity. In this example, the security information is the date of birth. Here, the system processor 111 first begins by prompting the user to enter his or her year of birth at step 1401. Once entered, the processor 111 stores the response in memory 113 and then prompts the user to enter their month of birth at step 1401b. Once entered, processor 111 again stores this response in memory 113 and then prompts the user to enter their day of birth at step 1401c and this information is also stored. After all security information has been entered, processor 111 compares it to the valid security information also stored in memory 113 to determine if it is valid at step 1402.

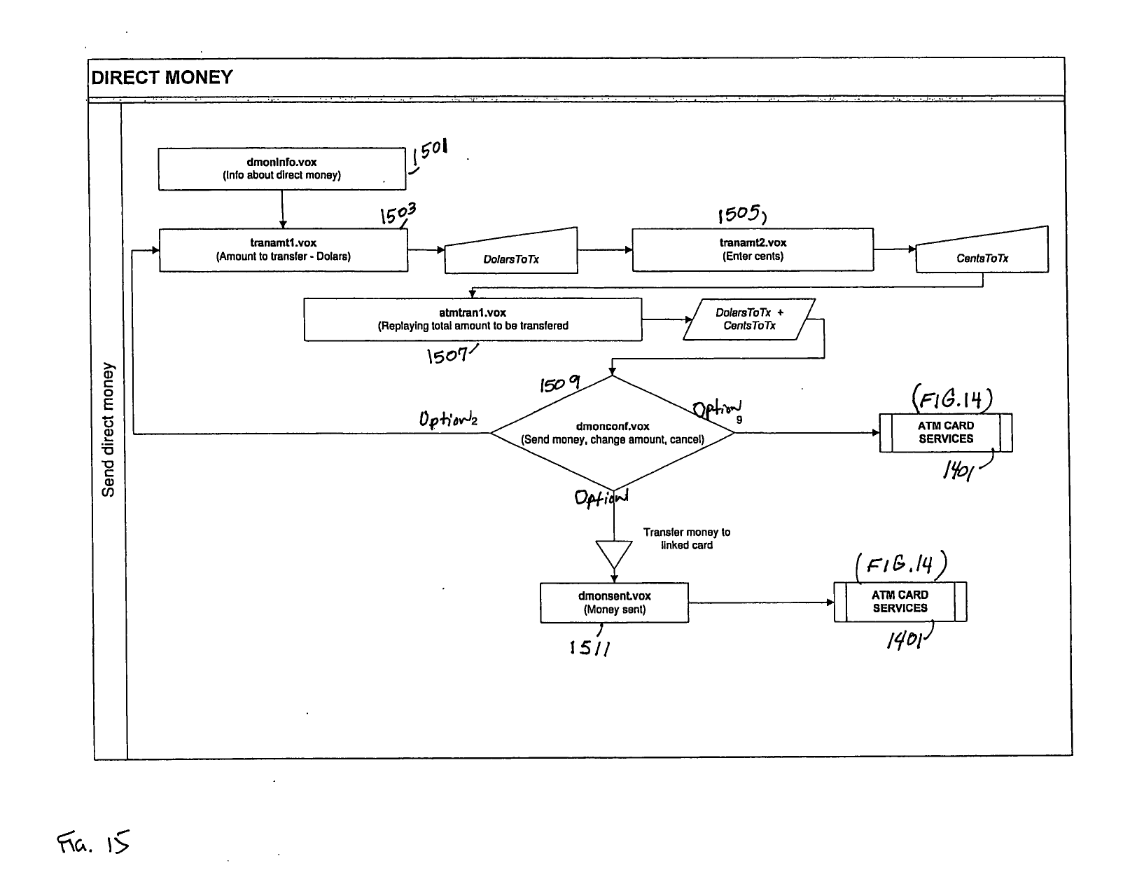

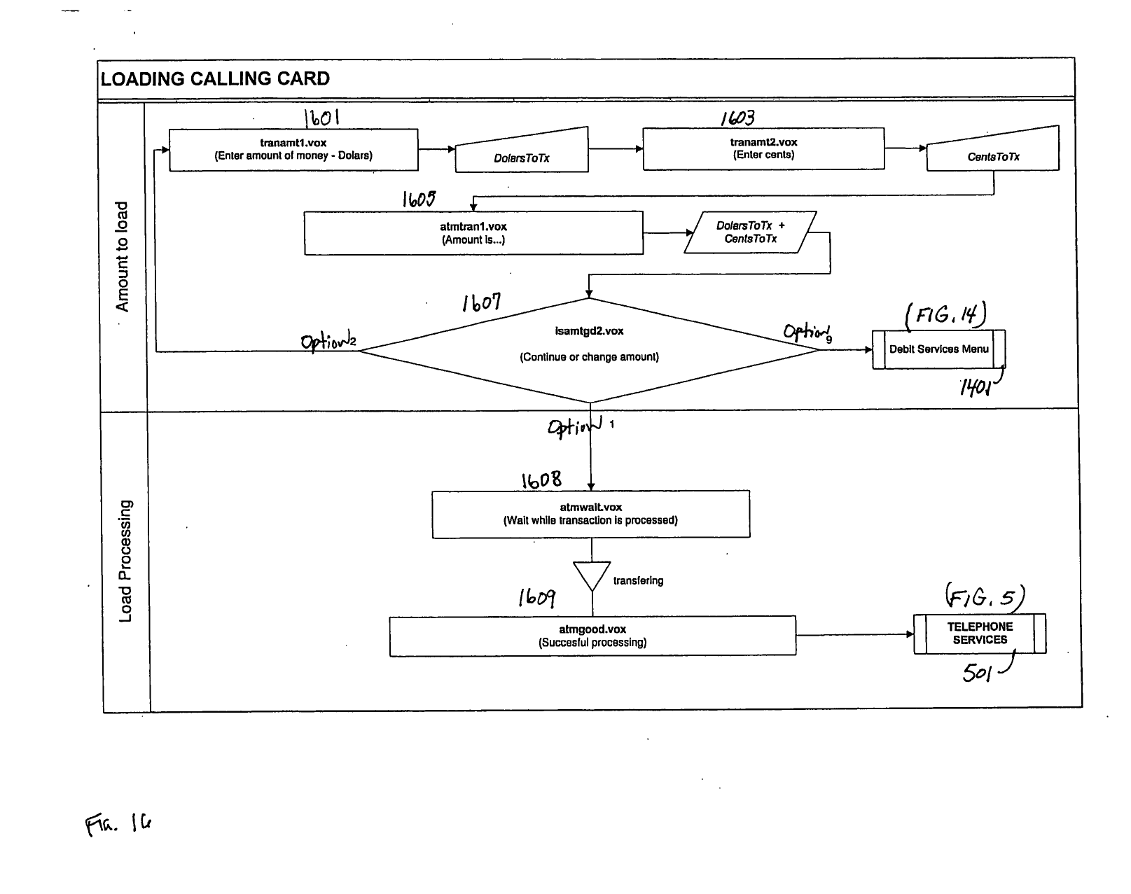

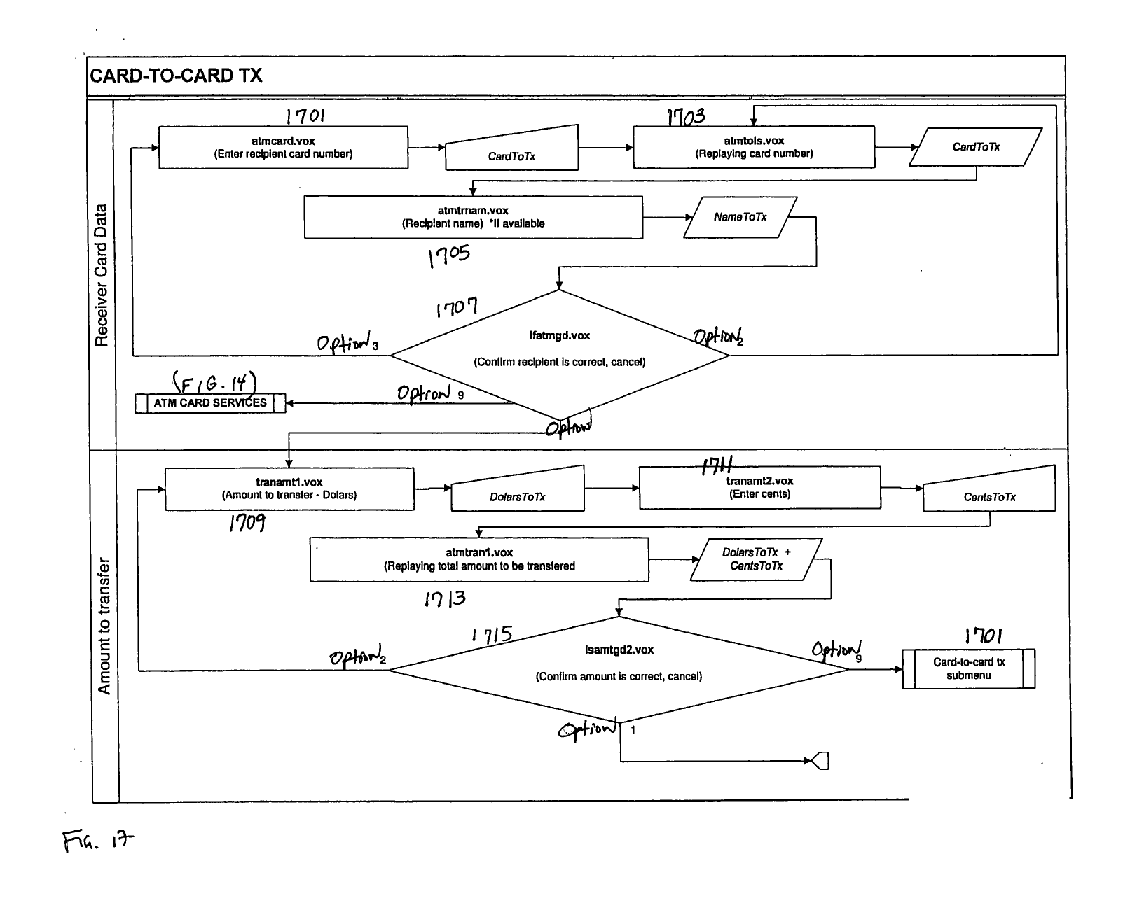

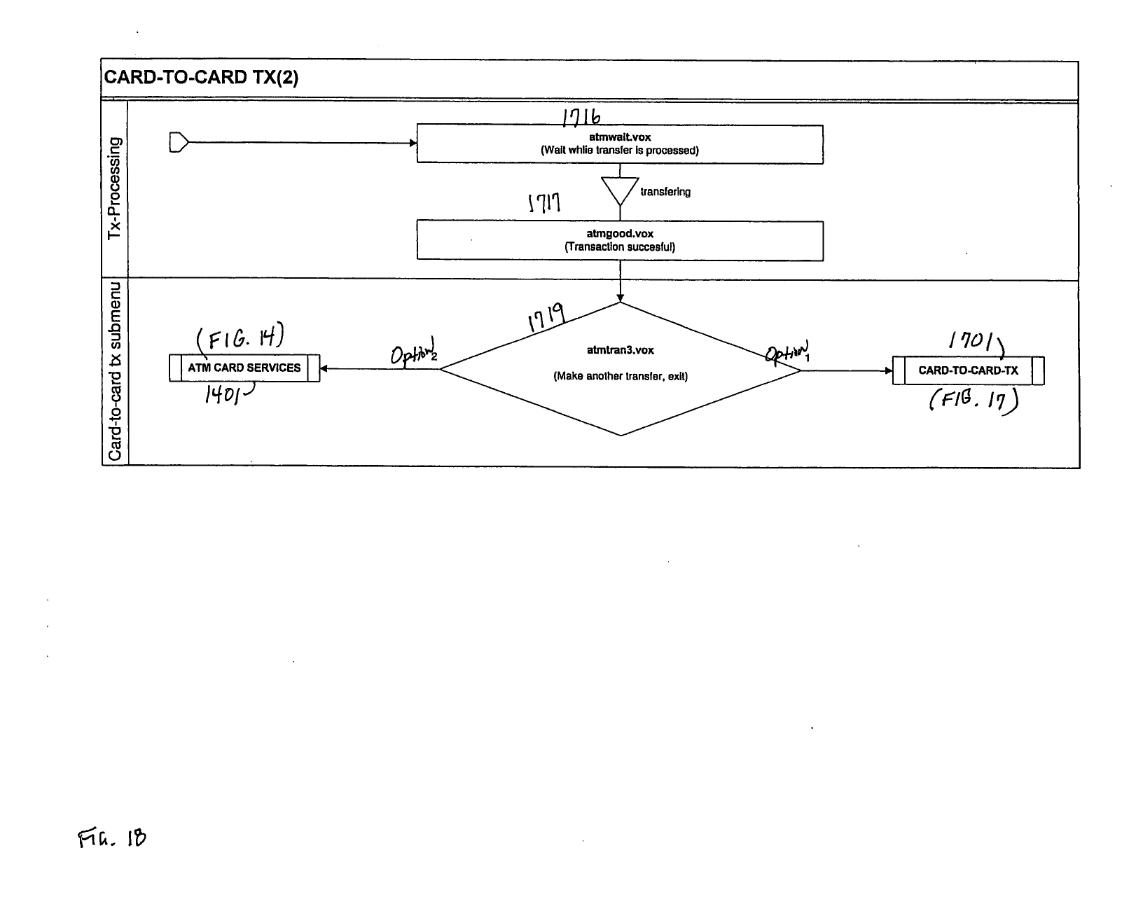

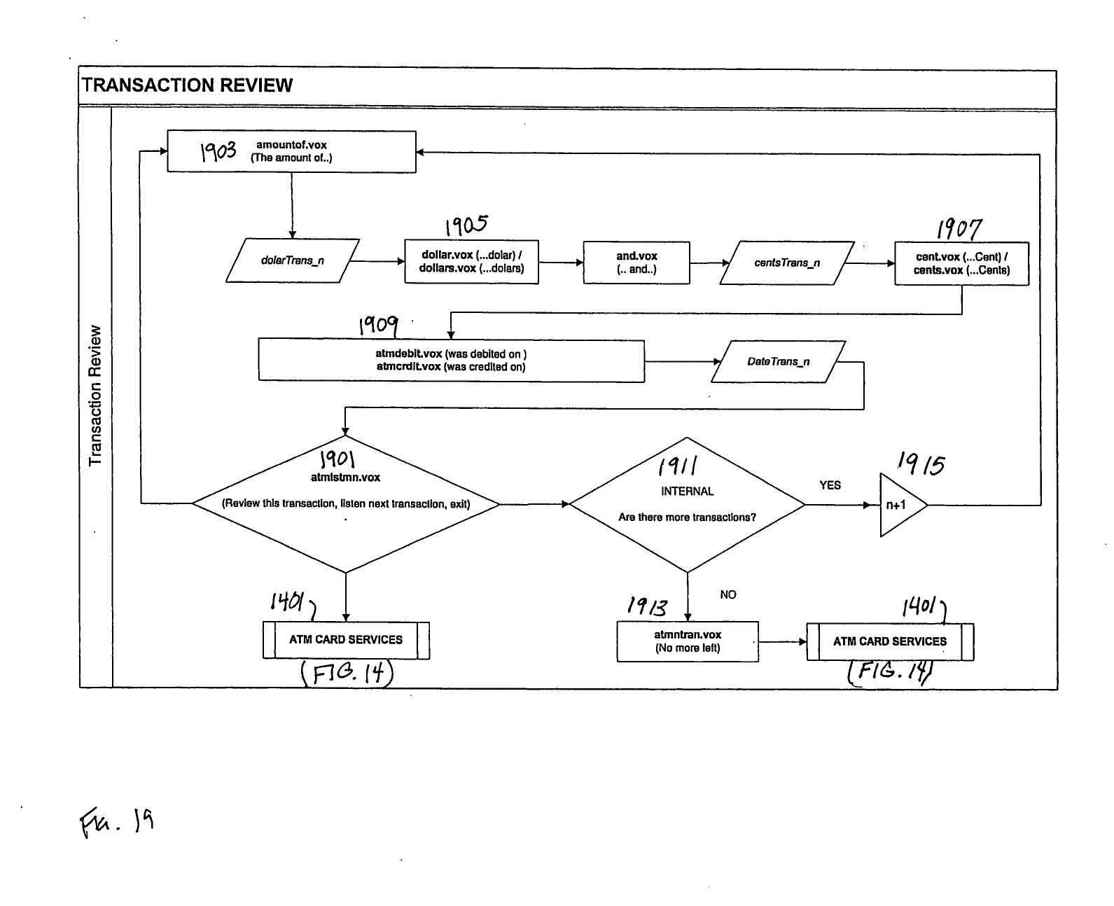

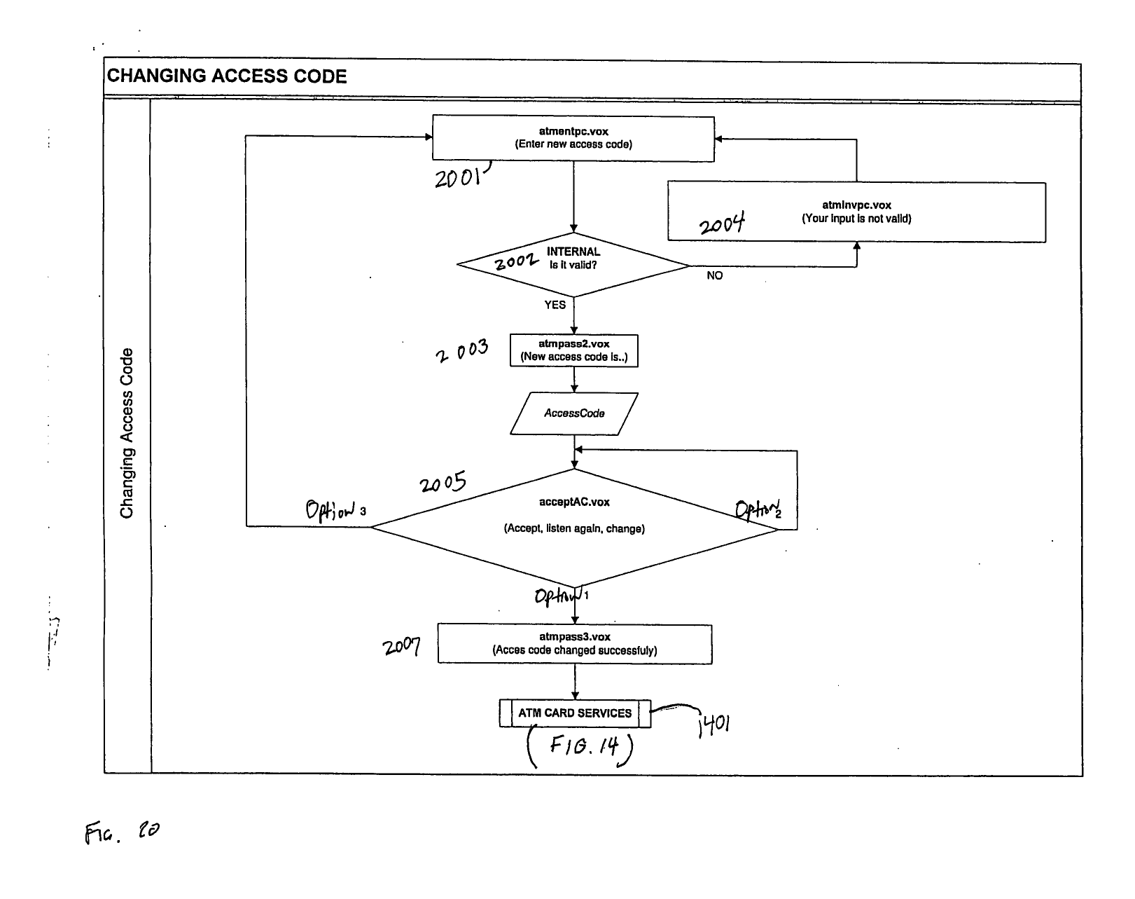

Once the security information is entered and verified, the user can obtain balances for both banking and telecommunications accounts as shown at steps 1403 and 1405. Here, processor 111 retrieves the ATM and calling card balance of the user from memory 113 and replays it. After the calling card balance has been replayed, processor 111 forwards the user to step 1407, the ATM/debit card services main menu, where the user is given a variety of options. These services can allow the user to load calling cards (Option #2, FIG. 16), transfer money to other cards (Option #3, FIG. 17 and 18), review transactions (Option #4, FIG. 19), make direct money transfers (Option #1, FIG. 15), check ATM balances (Option #5, step 1401), change access codes (Option #6, FIG. 20), speak with customer services (Option #0, step 1409), or access the main menu (Option #9, FIG. 4). Once selected, the processor 111 forwards the user to the requested automation. Also, when used at an ATM machine, the card 5 can be used just as any ATM card in the conventional manner to perform transactions such as money withdrawals and inquiries.

Referring to FIG. 14, if the user selects Option #1, processor 111 transfers the user to the Direct Money feature, which allows the user, via the keypad, to direct processor 111 to transfer stored electronic funds to other linked cards as will be discussed later in relation to FIG. 15. If, the user selects Option #2, processor 111 transfers the user to the Load Calling Card feature of the present invention, which is discussed later in relation to FIGS. 17 and 18. If the user selects Option #4, processor 11 transfers the user to the Transfer Review feature of the present invention, which is discussed later in relation to FIG. 19. If the user selects Option #5, the system processor 111 replays the current ATM balance of the user at step 1409. If the user selects Option #6, processor 111 transfers the user to the Changing Access Code feature of the present invention, which is discussed later in relation to FIG. 20. If the user selects Option #0, processor 111 transfers the user to customer service at step 1411. Lastly, if the user selects Option #9, processor 111 transfers the user to the Main Menu feature, which was discussed above in relation to FIG. 4.

Referring to the high level flow chart of FIG. 15, the integrated card system of the present invention includes a direct money function in which the user can send money directly to a linked card in the integrated card system of the present invention without having to type the card number that money is to be transferred to. This feature can be accessed through the IVR or the Internet and allows an easy, fast and secure way to transfer money to another card in the integrated card system.

Referring to the preferred embodiment of FIG. 15, once the user accesses the direct money feature through the IVR or Internet, the flow chart begins with step 1501 where processor 111 retrieves stored audio messages from memory 113 containing information about the direct money features and options and replays the messages to the user. Next, in step 1503, processor 111 retrieves from memory 113 and replays a message which prompts the user to enter a dollar amount to be transferred to the linked card. After the user has entered the dollar amount, the processor 111 replays a message which prompts the user to enter the cent amount at step 1505. Once the dollar and cent amount has been entered, processor 111 directs memory 113 to store the data. Once this has be done, at step 1507, processor 111 retrieves from memory 113 and replays the amount entered by the user (or display the amount if accessed through the Internet) in dollars and cents. Once the user has heard the amount, he or she may verify or cancel the transaction in step 1509. If the user chooses the change the amount of the electronic funds to be transferred under Option #2, the user enters the presses the required key on the keypad and processor 111 will begin again at step 1503 and follow the previously-mentioned steps. If the user decides to cancel the transfer under Option #9, the user enters the desired key and processor 111 forwards the user to the ATM Card Services feature of FIG. 14. If, however, the user verifies the amount under Option #1, processor 111 directs the electronic fund transfer to the linked card in step 1511 without the user having to enter any account information related to the linked card. After the electronic funds have been transferred, the system processor 111 forwards the user to the ATM Card Services feature of FIG. 14.

In the preferred embodiment, referring to FIG. 16, the user can transfer money from the user's account funds to the user calling card account via the IVR or Internet. Additionally, it is possible for the user to transfer funds to a prepaid mobile account or other telecommunications account supported by the integrated card system. The user will have the option of transferring either predefined amounts such as $5, $10, $20, $50, or $100 dollars, or to enter a specified amount of through the use of the telephone keypad or other data entry device used in conjunction with Internet transactions.

Referring to FIG. 16, once the user has accessed the system through the IVR or Internet, the user is prompted by the processor 111 to enter a dollar amount to be loaded onto the calling card in step 1601. Once entered, processor 111 directs the memory 113 to store the entered amount and the user is them prompted by processor 111 to enter a cent amount in step 1603. Once entered, processor 111 again directs memory 113 to store the entered amount and processor 111 replays the amount entered by the user in dollars and cents in step 1605. Once replayed, the processor 111 gives the user the option to verify or cancel the transaction or exit in step 1607. If the user decides to cancel the transaction under Option #2, processor 111 restarts at step 1601 and begin the process again. If the user chooses to exit the loading feature, processor 111 transfers the user to the Debit Services feature of FIG. 14 discussed above. If, on the other hand, the user verifies the transaction under Option #1, after a brief processing time of step 1608, processor 111 transfers the money in step 1609 and the card is loaded. After the card is loaded, processor 111 transfers the user to the Telephone Services menu of FIG. 5 discussed above.

Referring to FIGS. 17 and 18, the user can transfer funds from the user's integrated card 5 to any other integrated card 5 in the integrated card system by entering the account number of the integrated card 5 to receive the finds. This function provides a very easy and convenient way to perform money transfers to any other user on the integrated card system of the present invention.

Referring to FIGS. 17 and 18, once the user has accessed the system through the IVR or Internet, he or she is prompted to enter the recipient's card number at step 1701. Once entered, processor 111 replays the recipient's card number and name retrieved from the memory 113, if available, in steps 1703 and 1705 respectively. Next, in step 1707, processor 111 allows the user to confirm the recipient replayed by the system is the correct. If incorrect, the user selects Option #3 and processor 111 cancels the transaction and begins again at step 1701. If the user decides to exit the transaction under Option 9, processor 111 transfers the user back to the ATM Card Services feature of FIG. 14 discussed above. The user is also given the option of replaying the card number and name under Option #2 where processor 111 transfers the user back to step 1703 and the process begins again.

If, however, the intended recipient is correct, the user selects Option #1 and processor 111 prompts the user to enter a dollar and cent amount in steps 1709 and 1711 respectively. Once entered, processor 111 directs the memory 113 to store the amount and, at step 1713, system processor 111 retrieves from memory 113 and replay the total amount in dollars and cents to be transferred. Once replayed, the user is allowed to cancel, change, or verify the transaction at step 1715. If cancelled, the user selects Option #9 and the system begins again at step 1701. If the user decides to change the amount to be transferred under Option #2, the user inputs the required keystroke and processor 111 transfers the user back to step 1709 and the process begins again. If, however, the transaction is verified under Option #1, after the brief processing time of step 1716, the processor 111 transfers the specified electronic fund amount to the specified card account in step 1717. The processor 111 then gives the user the option of making another transaction or exiting the system in step 1719. If the user selects Option #1, processor 111 forwards the user back to step 1701 of the Card to Card Transactions feature of FIG. 17. If, however, the user selects Option #2, processor 111 transfers to the ATM Card Services menu of FIG. 14.

In FIG. 19, the user can, as shown, review the transactions completed including the transaction date, the transaction amount, and the transaction type. Additionally, the user may obtain the current balance of funds associated with the user's integrated card 5. The options of this feature begin at step 1901. Here, processor 111 presents the user with the options to review the current transaction, listen to another transaction, or exit. If the user chooses to listen to the current transaction, the user inputs the required keystroke and the system processor 111 then transfers the user to step 1903, where in steps 1905 and 1907 processor 111 retrieves from memory 113 and replays the amount of the transaction in dollars and cents. Thereafter, in step 1909 system processor 111 retrieves from memory 113 and replay the date the transaction occurred. After this is replayed, processor 111 forwards the user back to step 1901. If the user chooses to exit the feature, after inputting the desired keystroke, processor 111 transfers the user to the ATM Card Services feature discussed above under FIG. 14.

If, however, the user chooses to listen to the next transaction, processor 111 performs an internal check in its memory 113 to determine whether there are any more transactions under step 1911. If there are no more transactions on the internal network under step 1913, processor 111 transfers the user back to the ATM Card Services menu of FIG. 14. If, however, it is determined there are other transactions on the internal network under step 1915, processor 111 transfers the user back to step 1903 and the next transactions is replayed as previously discussed.

Referring to FIG. 20, the user has the ability to change the access code for the user's integrated card 5. Once the user has selected this function in the keypad, at step 2001, processor 111 prompts the user to enter the new access code. Once entered, processor 111 stores the entered code in its memory 113. The processor 111 then checks internal records in its memory 113 to ascertain whether the input is valid at step 2002. If the input is determined to be invalid under step 2004 by processor 111, processor 111 again prompts the user to enter the new access code at step 2001. If, however, the access code is valid, the user is allowed to listen to the code at step 2003 and decide whether to accept, replay, or change the access code at step 2005. If the user chooses to change the code under Option #3, the user is again prompted to step 2001 and the process begins again. If the user chooses to replay the access code again under Option #2, processor 111 transfers the user back to step 2003, retrieves the entered code from its memory 113, and replays the access code. If, however, the user accepts the new access code under Option #1, processor 111 changes the code to reflect the user's desire at step 2007. Once complete, 111 transfers the user back to the ATM Card Services feature of FIG. 14.

In addition, several other functionalities may be provided according to the present invention. For example, the user can reload the integrated card 5 using a third card provided by the integrated card system. This third card can be used at any POS device designed, adapted, or reprogrammed for this purpose. This third card is linked to the user's primary integrated card 5. The user presents the third card at a POS device with the funds to be placed on the card and requests that the card be reloaded. The third card is then swiped or otherwise accessed through the POS device, and the amount of funds is then associated with the user's integrated card 5. In addition, the user can have the user's payroll check or wages directly deposited onto the integrated card 5 account.

As another feature, the integrated card system may provide special bonuses and incentives to users for using their integrated card 5. These promotions can be based on the amount of calling time used; the amount of goods purchased, accumulation of points, instant prizes, or based on referrals. Also, the integrated card system allows the user to pay bills using the card 5. This can be done through the IVR, website or at a POS station. In addition, the integrated card system can offer accidental death or dismemberment insurance, for example, to a primary card holder.

Having described the invention above, various modifications of the techniques, procedures, components and equipment will be apparent to those skilled in the art. It is intended that all such variations within the scope and spirit be embraced thereby.

We claim:

1. A method of providing integrated multi-service stored machine readable card values for providing integrated telecommunication and financial services, the method comprising the steps of:
loading a primary card with a stored electronic fund value and identification information;
permitting cash withdrawals from the stored electronic fund value of the primary card at a user access site;
transferring funds electronically from the primary card to one or more secondary cards, the secondary cards also having a stored electronic fund value and identification information thereon; and
permitting telecommunications transactions to be performed using the stored electronic fund value of the primary and secondary cards.

2. The method of claim 1, further comprising the step of permitting charge purchases using the primary or secondary cards to be deducted from the stored electronic fund value.

3. The method of claim 1, further comprising the step of permitting cash withdrawals from the stored electronic fund value of the secondary cards at the user access site.

4. The method of claim 1, further comprising the step of allowing a user to recharge the stored electronic fund value of the primary and secondary cards through the user access site.

5. The method of claim 1, wherein the step of permitting telecommunications transactions includes the steps of:
permitting a user to make calls using a prepaid mobile telephone account; and
permitting a user to recharge the prepaid mobile telephone account with the stored electronic fund value of the primary or secondary cards through the user access site.

6. The method of claim 1, wherein the step of permitting telecommunications transactions includes the steps of:
permitting the primary or secondary cards to act as a calling card; and
permitting a user to recharge the stored electronic fund value of the calling card through the user access site while conducting a call using the calling card.

7. The method of claim 1, further comprising the step of allowing the stored electronic fund value of the primary or secondary cards to be recharged with electronic funds available in an ATM account.

8. The method of claim 1, wherein the step of permitting telecommunications transactions includes the step of allowing a user to send and receive voice mail messages through the user access site from other users on the card system.

9. The method of claim 1, further comprising the step of maintaining separate stored electronic fund balances for telecommunications and financial transactions.

10. An integrated multi-service stored value card system for providing integrated telecommunications and financial services, the card system comprising:
a primary card capable of storing machine readable electronic and identification information thereon;
one or more secondary cards capable of storing machine readable electronic and identification information thereon;
a computer network which allows the primary and secondary cards to provide telecommunications and financial services to a user through a user access site; and
a communications network, the communications network linking the primary and secondary cards and allowing a user to communicate electronic instructions to the computer network from the user access site to perform instantaneous electronic transactions between the primary and secondary cards.

11. The integrated multi-service stored value card system of claim 10, wherein the financial services provided by the computer network comprise allowing a user to transfer electronic funds between the primary and secondary cards in response to the electronic instructions sent to the computer network from the user access site.

12. The integrated multi-service stored value card system of claim 10, wherein the computer network allows the user to recharge a stored electronic find value of the primary and secondary cards in response to the electronic instructions sent from the user access site.

13. The integrated multi-service stored value card system of claim 10, wherein the computer network maintains a card account, the card account having separate stored electronic fund balances for telecommunications and financial transactions.

14. The integrated multi-service stored value card system of claim 10, wherein the computer network telecommunications services include directing the computer system to recharge a stored electronic find value of a prepaid mobile telephone account from the electronic instructions received from the user access site.

15. The integrated multi-service stored value card system of claim 10, wherein:
the computer network provides telecommunications services that allow the primary or secondary cards to act as a calling card; and,
in response to the electronic instructions sent from the user access site, the computer network also being capable of recharging a stored electronic fund value balance of the calling card while using the calling card to conduct a call.

16. The integrated multi-service stored value card system of claim 13, wherein:
the computer network links the card account to an ATM account of the user; and
in response to the electronic instructions sent from the user access site, the computer network further allowing the user to recharge a stored electronic fund value of the card account with electronic funds available in the ATM account.

17. The integrated multi-service stored value card system of claim 10, wherein the telecommunications services provided by the computer network include allowing the user to send and receive voice mail messages from other card system users.

18. The integrated multi-service stored value card system of claim 10, wherein the computer network further allows the user to access a call forwarding feature in response to the electronic instructions sent from the user access site.

19. The integrated multi-service stored value card system of claim 10, wherein the access site is selected from the group consisting of an automated voice response system, the Internet, or a point of sale terminal.

20. A computer program storage device readable by a machine, tangibly embodying a machine readable code of program instructions executable by the machine to perform method steps of providing integrated multi-service stored machine readable card values for providing integrated telecommunication and financial services, the method steps of the program instructions in the machine readable code in the program storage device comprising the steps of:
loading a primary card with a stored electronic fund value and identification information;
permitting cash withdrawals from the stored electronic fund value of the primary card at a user access site;
transferring funds electronically from the primary card to one or more secondary cards, the secondary cards also having a stored electronic fund value and identification information thereon; and
permitting telecommunications transactions to be performed using the stored electronic fund value of the primary and secondary cards.

21. The computer program storage device of claim 20, wherein the method steps of the program instructions in the machine readable code in the program storage device further include the step of permitting charge purchases using the primary or secondary cards to be deducted from the stored electronic fund value.

22. The computer program storage device of claim 20, wherein the method steps of the program instructions in the machine readable code in the program storage device further include the step of permitting cash withdrawals from the stored electronic fund value of the secondary cards at the user access site.

23. The computer program storage device of claim 20, wherein the method steps of the program instructions in the machine readable code in the program storage device further include the step of allowing a user to recharge the stored electronic fund value of the primary and secondary cards through the user access site.

24. The computer program storage device of claim 20, wherein the method steps of the program instructions in the machine readable code in the program storage device further include the step of:
permitting a user to make calls using a prepaid mobile telephone account; and
permitting a user to recharge the prepaid mobile telephone account with the stored electronic fund value of the primary or secondary cards through the user access site.

25. The computer program storage device of claim 20, wherein the method steps of the program instructions in the machine readable code in the program storage device further include the step of:
permitting the primary or secondary cards to act as a calling card; and
permitting a user to recharge the stored electronic fund value of the calling card through the user access site while conducting a call using the calling card.

26. The computer program storage device of claim 20, wherein the method steps of the program instructions in the machine readable code in the program storage device further include the step of allowing the electronic fund stored value of the primary or secondary cards to be recharged with electronic funds available in an ATM account.

27. The computer program storage device of claim 20, wherein the method steps of the program instructions in the machine readable code in the program storage device further include the step of allowing a user to send and receive voice mail messages through the user access site from other users on the card system.

28. The computer program storage device of claim 20, wherein the method steps of the program instructions in the machine readable code in the program storage device further include the step of providing separate stored electronic fund balances for telecommunications and financial transactions.
